(19) United States
(12) Patent Application Publication
(10) Pub. No.: US 2005/0209364 A1
(43) Pub. Date: Sep. 22, 2005

(54) Polymerizable compound, high-molecular compound, recording medium, recording medium/functional substance dispersed composition set, and liquid-applying method and liquid-applying apparatus using same

(75) Inventors: Keiko Yamagishi, Ebina-shi (JP); Koichi Sato, Atsugi-shi (JP); Ikuo Nakazawa, Zama-shi (JP); Ryuji Higashi, Atsugi-shi (JP); Sakae Suda, Sagamihara-shi (JP); Masayuki Ikegami, Atsugi-shi (JP); Keiichiro Tsubaki, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/068,766

(22) Filed: Mar. 2, 2005

(30) Foreign Application Priority Data
Mar. 5, 2004 (JP) 2004-062473 (PAT.
May 7, 2004 (JP) 2004-139192 (PAT.

(51) Int. Cl. C09D 11/00; C03C 17/00

(52) U.S. Cl. 523/160; 523/161

(57) ABSTRACT

A composition and a recording medium are disclosed including a polymer having as a repeating structural unit an alkenyl ether structure exhibiting cationic properties. Also disclosed is a recording medium/functional-substance dispersed composition set including a combination of the above recording medium and a functional-substance dispersed composition which exhibits anionic properties and contains an aqueous medium and a functional substance; and a liquid-applying method and a liquid-applying apparatus which make use of the set.

### BACKGROUND OF THE INVENTION

1. Field of the Invention

This invention relates to a novel polymerizable compound and a novel high-molecular compound which are useful as various functional materials, and a composition making use of them, as well as an image recording method and an image recording apparatus. More particularly, this invention relates to a recording material making use of such compounds together with a solvent or a dispersion medium and a coloring material, and also to an image recording method and an image recording apparatus which make use of the recording material.

2. Related Background Art

In recent years, digital printing technique is making rapid progress. What is called, electrophotographic technique or ink jet technique is a typical example of the digital technique whose value is increasingly raised as image forming technique in offices, homes and so forth.

In particular, the ink jet technique has great characteristic features such as compactness and low power consumption as a direct recording method. Also, due to miniaturization of nozzles, image quality is being rapidly improved. An example of the ink jet technique is a method in which an ink fed from an ink tank is heated with heaters in nozzles to bubble, whereupon the ink is ejected to form images on a recording medium. Another example is a method in which an ink is ejected from nozzles by vibrating piezoelectric elements.

As inks used in such ink-jet recording, ink compositions or toner compositions are prepared by dissolving or dispersing coloring materials. Various kinds of high-molecular materials are preferably used therefor. For example, high-molecular compounds of styryl, acrylic and methacrylic types are used. In coloring material compositions making use of a solvent or water as a base material, high-molecular materials preferably having an ionic functional group are utilized so that coloring materials such as pigments can be improved in dispersibility. Such attempts also have been commonly performed.

Meanwhile, a high-molecular compound having a polyalkenyl ether backbone chain is also known as a high-molecular material having a flexible high-molecular chain. However, there is almost no report concerning the introduction of a basic functional group into a repeating structural unit of that high-molecular compound. A phthalimide compound is disclosed as a compound having such a possibility (T. Hashimoto, H. Ibuki, M. Sawamoto and T. Higashimura, J. Polym. Sci., A, Polym. Chem., 26, p. 3361, 1988). However, under the existing condition, stabler one is desired, and at the same time, compounds having various properties are also required.

Aqueous dye solutions are usually used as inks for the ink-jet recording, and hence it comes about in some cases that colors adhere when images are rubbed after printing, inks bleed from trailing edges when images are traced with a marker, or inks adhere to another sheet of paper when prints are piled up after printing. With the aim of remedying such defects, as disclosed in, e.g., Japanese Patent Application Laid-Open No. H08-58225, an image forming method and an image forming apparatus are proposed in which a recording medium is coated with cationic polymer particles capable of reacting with an anionic dye in a ink, the ink is ejected onto the cationic polymer particles through an ink-jet recording head, and cationic polymer particles having reacted with the ink are fixed to the recording medium to form images. However, further improvement such as improvement in fixing performance is desired.

### SUMMARY OF THE INVENTION

The present invention has been made taking into account such problems the background art has had, and provides a stable and novel high-molecular compound which is suitable for improving the dispersibility of coloring materials or solid matter in ink compositions or toner compositions. The present invention also provides an image forming method and an image forming apparatus using a recording material such as a liquid composition and a toner composition utilizing the high-molecular compound.

The present invention still also provides a recording medium comprising a polymer having as a repeating structural unit an alkenyl ether structure exhibiting cationic properties.

As a result of extensive studies, the present inventors have come to accomplish the invention shown below.

A first aspect of the present invention is concerned with a polymerizable compound represented by the following general formula (1):
XO(AO)mBD (1)
wherein X represents an alkenyl group; A represents a substituted or unsubstituted, straight-chain or branched alkylene group having 1 to 15 carbon atoms; m represents an integer of 0 to 30, and when m is plural, A's may be different; B represents a single bond or a substituted or unsubstituted alkylene group; and D represents an aromatic amine or amino group, or an acid salt thereof.

A second aspect of the present invention is a high-molecular compound having a repeating structural unit represented by the following general formula (2): 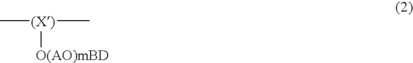
wherein X′ represents an alkenyl group; A represents a substituted or unsubstituted, straight-chain or branched alkylene group having 1 to 15 carbon atoms; m represents an integer of 0 to 30, and when m is plural, A's may be different; B represents a single bond or a substituted or unsubstituted alkylene group; and D represents an aromatic amine or amino group, or an acid salt thereof.

Preferable examples of the alkenyl group may include ethenyl (or vinyl), propenyl, butenyl, pentenyl and hexenyl.

As examples of the aromatic amine group, it may include substituted or unsubstituted pyridine, quinoline and pyrimidine.

A third aspect of the present invention is a composition comprising the high-molecular compound having a repeating structural unit represented by the above general formula (2), a solvent or a dispersion medium, and a functional substance.

A fourth aspect of the present invention is a recording medium containing a polymer having as a repeating structural unit an alkenyl ether structure exhibiting cationic properties.

A fifth aspect of the present invention is a recording medium/functional-substance dispersed composition set comprising a combination of i) a recording medium containing a polymer having as a repeating structural unit an alkenyl ether structure exhibiting cationic properties and ii) a functional-substance dispersed composition which exhibits anionic properties and contains an aqueous medium and a functional substance.

The above polymer may preferably have at least a kind of repeating structural unit represented by the above general formula (2).

The above alkenyl ether structure is preferably a vinyl ether structure.

The above recording medium is preferably paper.

The above functional-substance dispersed composition may preferably be an ink composition prepared by dispersing an anionic water-soluble dye or a fat-soluble dye or pigment in an aqueous medium by using an anionic dispersant.

The above functional-substance dispersed composition may also preferably be an ink composition prepared by dispersing a fat-soluble dye or pigment in an aqueous medium by using a polymer having as a repeating structural unit a vinyl ether structure exhibiting anionic properties.

A sixth aspect of the present invention is a set of i) a recording medium comprising the above composition and ii) an ink composition.

The above ink composition may preferably be an ink composition for ink-jet recording.

A seventh aspect of the present invention is a liquid-applying method which comprises making use of the above recording medium/ink composition set.

An eighth aspect of the present invention is a liquid-applying apparatus used in the above liquid-applying method.

According to the present invention, a high-molecular compound can be provided which is suitable for improving the dispersibility of coloring materials or solid matter in ink compositions or toner compositions.

According to the present invention, the recording medium can be provided which contains a polymer having as a repeating structural unit an alkenyl ether structure exhibiting cationic properties. Also, the recording medium and the functional-substance dispersed composition which exhibits anionic properties and contains an aqueous medium and a functional substance, are used in combination to provide a recording medium/recording composition set which can form printed images with good fixability.

According to the present invention, a recording medium/recording composition set can also be provided in which the recording medium is paper containing the cationic polymer, the functional substance is a pigment or a dye and the solvent is water and which can form printed images with good fixability.

According to the present invention, the recording medium/recording composition set may also be used to provide a liquid-applying method which can form printed images with good fixability and a liquid-applying apparatus which makes use of the same.

### BRIEF DESCRIPTION OF THE DRAWINGS

FIG. 1 is a schematic view showing the structure of an image forming apparatus according to the present invention.

FIG. 2 is a ¹H NMR chart of a compound CH₂═CHOCH₂CH₂O-(4-pyr) in Example 1 of the present invention.

### DESCRIPTION OF THE PREFERRED EMBODIMENTS

The present invention is described below in detail.

The present invention embraces a composition and a recording medium containing a polymer having as a repeating structural unit an alkenyl ether structure exhibiting cationic properties (hereinafter also “cationic polymer”). Also, the alkenyl ether structure may preferably be a vinyl ether structure.

The present invention also embraces a recording medium/functional-substance dispersed composition set comprising a combination of the above recording medium and a functional-substance dispersed composition which exhibits anionic properties and contains an aqueous medium and a functional substance. It may preferably a recording medium/ink composition set in which the functional-substance dispersed composition is an ink composition prepared by dispersing an anionic water-soluble dye or a fat-soluble dye or pigment in an aqueous medium by using an anionic dispersant.

In the present invention, the recording medium containing the cationic polymer and an ink composition which is the functional-substance dispersed composition exhibiting anionic properties may be used making a set, thereby materializing image formation improved in fixing performance of inks to the recording medium.

Where such an ink composition exhibiting anionic properties (hereinafter also “anionic ink composition”) has adhered to the recording medium containing the cationic polymer, it undergoes agglomeration or sol-gel transformation to thicken, whereby the fixing of a certain coloring material to the recording medium can be effected. However, when images formed are strongly rubbed, the images may be torn off together with the polymer, showing insufficient fixing performance in some cases.

On the other hand, in the polymer of the present invention having an polyvinyl ether structure exhibiting cationic properties, its backbone chain has a glass transition temperature of 20° C. or less and is flexible in molecular motion. Hence, when applied on a recording medium, the polymer is desirably entangled with fibers of the recording medium (paper), and hence, when the anionic ink composition is ejected to form images, a coloring material having undergone agglomeration or sol-gel transformation becomes desirably entangled with the recording medium, so that the high fixing performance to the recording medium is attained. Further, since the polymer of the present invention having a polyvinyl ether structure exhibiting cationic properties has an ether chain as a side chain, its adsorptivity on paper having cellulose increases. Thus, high fixing performance is attained when the anionic ink composition is ejected to form images.

In the present invention, inasmuch as the cationic polymer is incorporated in the recording medium, the anionic ink composition undergoes agglomeration to thicken regardless of types of recording mediums, whereby images improved in fixability are formed.

In addition, in the present invention, the functional-substance dispersed composition is more preferably an ink composition prepared by dispersing a fat-soluble dye or pigment in an aqueous medium by using a polymer having as a repeating structural unit a vinyl ether structure exhibiting anionic properties. In the case of the ink composition prepared by dispersing a fat-soluble dye or pigment by using a polymer having as a repeating structural unit a vinyl ether structure exhibiting anionic properties, it is desirably adsorbed on the polymer having a polyvinyl ether structure exhibiting cationic properties, contained in the recording medium, so that it is possible to further improve the fixing performance.

The recording medium containing the cationic polymer used in the present invention is one in which the cationic polymer is held on the surface of a substrate or in the whole medium, and there are no particular limitations on its structure.

The substrate usable in the present invention includes, but is not particularly limited to, paper such as woodfree paper, mechanical paper, art paper, bond paper, recycled paper, baryta paper, cast-coated paper and corrugated fiberboard paper; films or sheets formed of polymers or plastics such as polyethylene terephthalate, diacetate, triacetate, celophane, Celluloid, polycarbonate, polyimide, polyvinyl chloride, polyvinylidene chloride and polyacrylate; glass sheets; or cloths of cotton, Rayon, acrylate, nylon, silk or polyester. In the present invention, preferably used is paper such as woodfree paper, mechanical paper, art paper, bond paper, recycled paper, baryta paper, cast-coated paper and corrugated fiberboard paper.

The polymer used in the present invention, having as a repeating structural unit a vinyl ether structure exhibiting cationic properties or anionic properties is described here. Many methods for synthesizing polymers containing a polyvinyl ether structure are reported (see, e.g., Japanese Patent Application Laid-Open No. H11-080221). For example, a method by cationic living polymerization by Aoshima et al. (Polymer Bulletin Vol. 15, 1986, p. 417; Japanese Patent Applications Laid-Open No. H11-322942 and Japanese Patent Applications Laid-Open No. H11-322886) may be typically cited. Where polymers are synthesized by cationic living polymerization, homopolymers and copolymers composed of two or more kinds of monomers and also various polymers, such as block polymers, graft polymers and gradient polymers, uniform in length (molecular weight) can be synthesized. As for polyvinyl ethers, various functional groups can be introduced into their side chains. Cationic polymerization may be carried out in an HI/I2 system, an HC/SnCl4 system or the like.

The structure of the block polymer containing a polyvinyl ether structure may also be a copolymer composed of a vinyl ether and other polymers, and the copolymer may be a block polymer, a graft polymer, a gradient polymer or the like. To give specific examples of the block polymer that may be used in the present invention, conventionally known block polymers may be used, such as acrylic or methacrylic block polymers, block polymers of polystyrene with other addition polymers or condensation polymers, and block polymers having blocks of polyoxyethylene or polyoxyalkylene.

For the above polymer containing a polyvinyl ether structure exhibiting cationic properties, more specifically, it is preferable that the repeating structural unit of the polyvinyl ether structure exhibiting cationic properties is a unit structure represented by the following general formula (2): 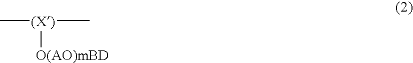
wherein X′ represents an alkenyl group; A represents a substituted or unsubstituted, straight-chain or branched alkylene group having 1 to 15 carbon atoms; m represents an integer of 0 to 30, and, when m is plural, A's may be different; B represents a single bond or a substituted or unsubstituted alkylene group; and D represents an aromatic amine or amino group, or an acid salt thereof.

Specific examples of the repeating structural unit exhibiting cationic properties represented by the general formula (2) are given below. Examples are by no means limited to these.

Counter anions may include Br⁻ and Cl⁻.

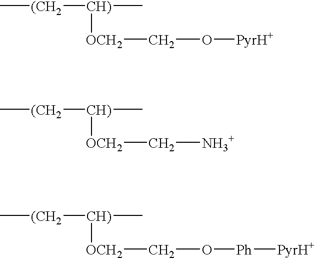

In such a cationic polymer, the repeating structural unit exhibiting cationic properties represented by the general formula (2) may be in a content ranging from 1 to 100 mol %, and preferably from 10 to 100 mol %. If it is in a content of less than 1 mol %, the fixing of the anionic ink composition to the recording medium, relying on the thickening due to agglomeration or sol-gel transformation, may come insufficient when the ink composition adheres to the recording medium.

The cationic polymer used in the present invention may preferably have a number-average molecular weight Mn of from 1,000 to 300,000. If the Mn is less than 1,000, the polymer may insufficiently be adsorbed on the recording medium. If on the other hand the Mn is more than 300,000, the coating solution may have too high viscosity to be uniformly applied on the substrate.

In order to improve fixing performance on the recording medium, it is preferred that the polymer is more flexible in molecular motion because it can have sites where it becomes physically entangled with the particle surfaces of the functional substance to readily have an affinity therefor. For this end, the backbone chain of the polymer may preferably have a glass transition temperature Tg of 20° C. or less, more preferably 0° C. or less, and still more preferably −20° C. or less. Even in this regard, the polymer having a polyvinyl ether structure may preferably be used because it commonly has a low glass transition temperature and has soft properties.

In the present invention, the polymer having as a repeating structural unit an alkenyl ether structure exhibiting cationic properties is by no means limited to a homopolymer, and may be a copolymer composed of two or more kinds of monomers, or a block polymer, a graft polymer or a gradient polymer.

In producing the recording medium of the present invention, there are no particular limitations. For example, the cationic polymer may be dissolved or dispersed in a solvent such as a suitable organic solvent or water to prepare a coating fluid with which the surface of a substrate is coated using roll coating, blade coating, air knife coating, gate roll coating, bar coating, size press coating, spray coating, gravure coating or curtain coating, followed by drying by means of, e.g., a hot-air drying oven or a hot drum to produce the recording medium containing the cationic polymer according to the present invention. The recording medium may further optionally be subjected to super calendering or the like in order to smoothen an ink-receiving layer or improve its surface strength.

During the coating, the cationic polymer may preferably be in a concentration of from 10 to 70% by weight. If it is in a concentration of less than 10% by weight, the surface of the substrate may come bare in part. If it is in a concentration of more than 70% by weight, the coating fluid may have too high viscosity to be uniformly applied on the substrate.

In the coating, the cationic polymer may be used alone or in an appropriate combination of several types.

In order to dissolve or disperse the cationic polymer in the solvent, alcohols or other organic solvents may also be added.

The coating weight of the ink-receiving layer may be from 0.2 to 50 g/m², and preferably from 0.2 to 20 g/m², in total. If the coating weight is too small, the substrate may partly come bare of the coating on the surface, which is undesirable. If the coating weight is more than 50 g/m², the dust fall of the coat layer may undesirably occur. Where the coating weight is expressed in terms of thickness, it may preferably be in such a range that the thickness of from 0.5 to 100 μm is provided.

The functional substance contained in the composition of the present invention refers to a substance having a stated function, and may include, e.g., compounds, mixtures, solids, liquids and substances having other forms. They may include, e.g., substances utilizable in agricultural chemicals such as herbicides and insecticides; substances utilizable as pharmaceuticals such as carcinostatics, antiallergic agents and antiphlogistics; substances utilizable as cosmetics such as lip sticks, foundations, cheek rouge and warming cream; and coloring materials such as dyes, pigments, color pigments, and compositions of these. In the present invention, coloring materials such as dyes, pigments and color pigments may preferably be used.

The solvent contained in the composition of the present invention is meant to be, but not particularly limited to, a medium capable of dissolving, suspending or dispersing ingredients contained in the composition. In the present invention, the solvent may include organic solvents such as various kinds of straight-chain, branched or cyclic aliphatic hydrocarbons, aromatic hydrocarbons, and heterocyclic aromatic hydrocarbons; water-soluble solvents; and water. In particular, water and a water-soluble solvent may preferably be used in the composition of the present invention.

Examples of the water-soluble solvent may include, e.g., polyhydric alcohols such as ethylene glycol, diethylene glycol, triethylene glycol, polyethylene glycol, propylene glycol, polypropylene glycol and glycerol; polyhydric alcohol ethers such as ethylene glycol monomethyl ether, ethylene glycol monoethyl ether, ethylene glycol monobutyl ether, diethylene glycol monoethyl ether and diethylene glycol monobutyl ether; and nitrogen-containing solvents such as N-methyl-2-pyrrolidone, substituted pyrrolidone, and triethanolamine. According to uses of inks, monohydric alcohols such as methanol, ethanol and isopropyl alcohol may be used for the purpose of accelerating drying on paper.

The solvent contained in the composition of the present invention may preferably be in a content of from 25 to 95% by weight, and more preferably in a content of from 30 to 90% by weight.

A composition in which a coloring material such as a dye, a pigment or a color pigment is used as the functional substance contained in the composition of the present invention may preferably be used as an ink composition.

The ink composition of the present invention is described below.

The anionic ink composition used in the present invention may be prepared by incorporating an anionic compound. For example, where a water-soluble dye containing an anionic group is used as the coloring material or a fat-soluble dye or pigment is used as the coloring material, the anionic ink composition may be obtained by the use of the anionic compound in combination. Such an anionic ink composition used in the present invention is made up by further incorporation of, in addition to the above, a liquid solvent such as water or a water-soluble organic solvent, and other components as exemplified by a viscosity modifier, a pH adjuster, an antiseptic, a surface-active agent and an antioxidant.

As the water-soluble dye containing an anionic group, used in the present invention, there are no particular limitations as long as it is a water-soluble acid dye, direct dye or reactive dye described in, e.g., Color Index. Also, even those not described in Color Index may be used without particular limitations as long as they have an anionic group as exemplified by a sulfonic group or a carboxyl group. Additionally, the water-soluble dye herein referred to include one whose solubility is different depending on pH.

Commercially available water-soluble dyes exhibiting anionic properties are exemplified below.

Such water-soluble dyes exhibiting anionic properties usable in the present invention may be known dyes, and include water-soluble dyes such as direct dyes and acid dyes as those given below.

Commercially available water-soluble dyes are exemplified below.

They may include direct dyes such as:
C.I. Direct Black 17, 19, 22, 32, 38, 51, 62, 71, 108, 146, 154;
C.I. Direct Yellow 12, 24, 26, 44, 86, 87, 98, 100, 130, 142;
C.I. Direct Red 1, 4, 13, 17, 23, 28, 31, 62, 79, 81, 83, 89, 227, 240, 242, 243;
C.I. Direct Blue 6, 22, 25, 71, 78, 86, 90, 106, 199;
C.I. Direct Orange 34, 39, 44, 46, 60;
C.I. Direct Violet 47, 48;
C.I. Direct Brown 109; and
C.I. Direct Green 59;
   and acid dyes such as:
C.I. Acid Black 2, 7, 24, 26, 31, 52, 63, 112, 118, 168, 175, 208;
C.I. Acid Yellow 11, 17, 23, 25, 29, 42, 49, 61, 71;
C.I. Acid Red 1, 6, 8, 32, 37, 51, 52, 80, 85, 87, 92, 94, 115, 180, 254, 256, 289, 315, 317;
C.I. Acid Blue 9, 22, 40, 59, 93, 102, 104, 113, 117, 120, 167, 229, 234, 254;
C.I. Acid Orange 7, 19; and
C.I. Acid Violet 49.

In addition, these examples of the coloring materials are particularly preferred for the ink composition of the present invention. The coloring material used in the ink composition of the present invention is not particularly limited to the above coloring materials.

In the present invention, a pigment and a dye may also be used in combination.

The dye used in the ink composition of the present invention may be preferably in an amount of from 0.1 to 50% by weight based on the weight of the ink composition. If the dye is in an amount of less than 0.1% by weight, sufficient image density may not be achievable. If the dye is in an amount of more than 50% by weight, the ink composition may have too high viscosity. The dye may be more preferably in an amount ranging from 0.5% by weight to 30% by weight.

The pigment used in the ink composition of the present invention may be preferably in an amount of from 0.1 to 50% by weight based on the weight of the ink composition. If the pigment is in an amount of less than 0.1% by weight, sufficient image density may not be achievable. If the pigment is in an amount of more than 50% by weight, the ink composition may have too high viscosity. The pigment may be more preferably in an amount ranging from 0.5% by weight to 30% by weight.

Another form of the anionic ink composition may be an ink composition which uses an oil-soluble dye or pigment as the coloring material instead of the above water-soluble dye containing an anionic group, further uses an anionic compound together with this, and contains a liquid solvent such as water or a water-soluble organic solvent, and optionally other components as exemplified by a viscosity modifier, a pH adjuster, an antiseptic, a surface-active agent and an antioxidant. Here, the anionic compound may also be a dispersant for the oil-soluble dye or pigment, and if the dispersant for the oil-soluble dye or pigment is not anionic, an anionic compound different from the dispersant may be added. Of course, even where the dispersant is the anionic compound, the different anionic compound may be added.

Commercially available oil-soluble dyes are exemplified below.

For example, the oil-soluble dyes may include, but are not limited to:
C.I. Solvent Blue 33, 38, 42, 45, 53, 65, 67, 70, 104, 114, 115, 135;
C.I. Solvent Red 25, 31, 86, 92, 97, 118, 132, 160, 186, 187, 219; and
C.I. Solvent Yellow 1, 49, 62, 74, 79, 82, 83, 89, 90, 120, 121, 151, 153, 154.

The pigment may be either of an organic pigment and an inorganic pigment. As pigments used in the ink composition, a black pigment and cyan, magenta and yellow three primary color pigments may preferably be used. In addition, color pigments other than the above, colorless or pale-color pigments, or metalescent pigments and the like may be used. In the present invention, commercially available pigments and pigments newly synthesized may also be used.

Pigments commercially available for black, cyan, magenta and yellow pigments are exemplified below.

The black pigments may include, but are not limited to, RAVEN 1060, RAVEN 1080, RAVEN 1170, RAVEN 1200, RAVEN 1250, RAVEN 1255, RAVEN 1500, RAVEN 2000, RAVEN 3500, RAVEN 5250, RAVEN 5750, RAVEN 7000, RAVEN 5000 ULTRA 11, and RAVEN 1190 ULTRA II (the foregoing are available from Columbian Carbon Japan Limited); BLACK PEARLS L, MOGUL-L, REGAL 400R, REGAL 660R, REGAL 330R, MONARCH 800, MONARCH 880, MONARCH 900, MONARCH 1000, MONARCH 1300, and MONARCH 1400 (the foregoing are available from Cabot Corp.); COLOR BLACK FW1, COLOR BLACK FW2, COLOR BLACK FW200, COLOR BLACK 18, COLOR BLACK S160, COLOR BLACK S170, SPECIAL BLACK 4, SPECIAL BLACK 4A, SPECIAL BLACK 6, PRINTEX 35, PRINTEX U, PRINTEX 140U, PRINTEX V, and PRINTEX 140V (the foregoing are available from Degussa Corp.); and No. 25, No. 33, No. 40, No. 47, No. 52, No. 900, No. 2300, MCF-88, MA600, MA7, MA8, and MA100, (the foregoing are available from Mitsubishi Chemicals, Inc.).

The cyan pigments may include, but are not limited to, C.I. Pigment Blue 1, C.I. Pigment Blue, 2, C.I. Pigment Blue 3, C.I. Pigment Blue 15, C.I. Pigment Blue 15:2, C.I. Pigment Blue 15:3, C.I. Pigment Blue 15:4, C.I. Pigment Blue 16, Pigment Blue 22, and C.I. Pigment Blue.

The magenta pigments may include, but are not limited to, C.I. Pigment Red 5, C.I. Pigment Red 7, C.I. Pigment Red 12, C.I. Pigment Red 48, C.I. Pigment Red 48:1, C.I. Pigment Red 57, C.I. Pigment Red 112, C.I. Pigment Red 122, C.I. Pigment Red 123, C.I. Pigment Red 146, C.I. Pigment Red 168, C.I. Pigment Red 184, C.I. Pigment Red 202, and C.I. Pigment Red 207.

The yellow pigments may include, but are not limited to, C.I. Pigment Yellow 12, C.I. Pigment Yellow C.I. 13, C.I. Pigment Yellow 14, C.I. Pigment Yellow 16, C.I. Pigment Yellow 17, C.I. Pigment Yellow 74, C.I. Pigment Yellow 83, C.I. Pigment Yellow 93, C.I. Pigment Yellow 95, C.I. Pigment Yellow 97, C.I. Pigment Yellow 98, C.I. Pigment Yellow 114, C.I. Pigment Yellow 128, C.I. Pigment Yellow 129, C.I. Pigment Yellow 151, and C.I. Pigment Yellow 154.

As the dispersant for the oil-soluble dye or pigment, usable in the ink composition of the present invention, any dispersants may be used as long as they are water-soluble polymers having the function of dispersing the oil-soluble dye or pigment stably in water or an aqueous medium in virtue of the presence of anionic groups. In particular, preferred are those having a weight-average molecular weight in the range of from 1,000 to 30,000. Further preferred are those having a weight-average molecular weight in the range of from 3,000 to 15,000. Stated specifically, such polymers may include, e.g., hydrophobic monomers such as styrene, styrene derivatives, vinyl naphthalene, vinyl naphthalene derivatives, and aliphatic alcohol esters of α,β-ethylenically unsaturated carboxylic acids; or block copolymers, graft copolymers or random copolymers consisting of two or more kinds of monomers selected from acrylic acid, acrylic acid derivatives, maleic acid, maleic acid derivatives, itaconic acid, itaconic acid derivatives, fumaric acid, fumaric acid derivatives; or salts thereof. These polymers are alkali-soluble polymers which are soluble in aqueous solutions in which bases have been dissolved.

The water-soluble polymers may further be homopolymers consisting of hydrophilic monomers, or salts thereof. Also usable are water-soluble polymers such as polyvinyl alcohol, carboxymethyl cellulose, and naphthalene sulfonate formaldehyde condensation products. The water-soluble polymer described above should be used in an amount of from 0.1 to 50% by weight, and preferably from 0.5 to 30% by weight, based on the total weight of the ink composition. If the water-soluble polymer is in an amount of less than 0.1% by weight, the oil-soluble dye or pigment contained in the ink composition of the present invention may be unable to be sufficiently dispersed. If the water-soluble polymer is in an amount of more than 50% by weight, the ink composition may have too high viscosity.

It is preferable that the polymer having as a repeating structural unit a vinyl ether structure exhibiting anionic properties contains a repeating structural unit represented by the following general formula (3):

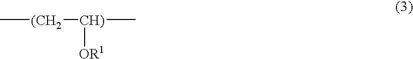

In the general formula (3), R¹ represents —X—COO⁻; and X represents a straight-chain, branched or cyclic alkylene group having 1 to 20 carbon atoms, or —(CH(R²)—CH(R³)—O)ₚ—(CH₂)ᵣ— or —(CH₂)ₛ—(O)ₜ—(CH₂)ᵤ— or a structure wherein at least one of these methylene groups is substituted with a carbonyl group or an aromatic ring structure, where:
p represent an integer of 1 to 18;
r represents an integer of 1 to 18;
s represents an integer of 1 to 36;
t represents an integer of 1 or 0;
u represents an integer of 1 to 18; and
R² and R³ each represent an alkyl group, and R² and R³ may be the same or different.

Specific examples of the repeating structural unit exhibiting anionic properties represented by the above general formula (3) are given below. Examples are by no means limited to these. 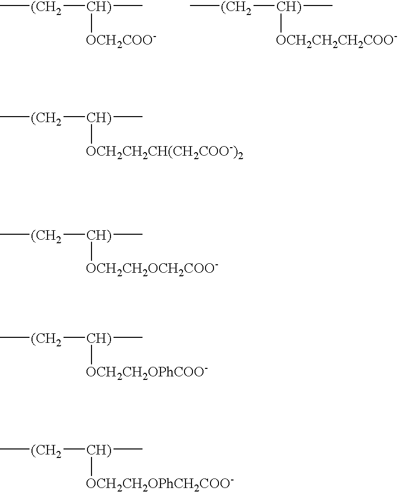
(Ph represents a phenylene group.)

In the present invention, the polymer having as a repeating structural unit a vinyl ether structure exhibiting anionic properties may preferably be an amphiphatic block polymer having at least one block segment exhibiting anionic properties. Where such an amphiphatic block polymer is used, it forms micelle particles each consisting of a hydrophobic segment at the core and a hydrophilic and anionic segment at the shell. Such micelle particles enable the fat-soluble dye or pigment to be enclosed in the cores. Hence, this also enables the fat-soluble dye or pigment to be sufficiently dispersed in the aqueous medium.

In the present invention, the repeating structural unit exhibiting anionic properties represented by the general formula (3) may be in a content ranging from 0.5 to 99 mol %, and preferably from 1 to 90 mol %. This is preferable because, as long as the content is in the range of from 0.5 to 99 mol %, the mutual action ascribable to the carboxylic acid is sufficiently brought out to fully exhibit the intended function.

The block polymer compound containing at least one segment exhibiting anionic properties in the present invention may have a number-average molecular weight Mn of from 200 or more to 10,000,000 or less, and as a range used preferably, from 1,000 or more to 1,000,000 or less. Where the Mn is 10,000,000 or less, the polymer is not excessively entangled within polymer chains and between polymer chains, and is readily dispersed in the solvent. Where the Mn is 200 or more, the steric effect of the polymer can be suitably exhibited. Each block segment may preferably have the polymerization degree of from 3 or more to 10,000 or less, and more preferably from 5 or more to 5,000 or less.

In order to improve the dispersion stability and the enclosing properties, it is preferred that the block polymer may be flexible in molecular motion because it can have sites where it becomes physically entangled with the fat-soluble dye or pigment to readily have an affinity therefor. For this end, the backbone chain of the block polymer may preferably have a glass transition temperature Tg of 20° C. or less, more preferably 0° C. or less, and still more preferably −20° C. or less. Even in this regard, the polymer having a polyvinyl ether structure may preferably be used because it commonly has a low glass transition temperature and has soft properties.

The oil-soluble dye or pigment dispersed ink composition usable in the present invention is made up by dispersing or dissolving the above pigment and water-soluble polymer in the aqueous medium.

Where the dispersant is not the anionic polymer, it is preferable that an anionic compound is further added to the ink composition containing the above oil-soluble dye or pigment. Such an anionic compound used preferably in the present invention may include high-molecular substances such as the alkali-soluble polymers described above, and besides low-molecular anionic surface-active agents as described below.

Specific examples of the low-molecular anionic surface-active agents may include, e.g., lauryl disodium sulfosuccinate, disodium sulfosuccinic acid polyoxyethylene lauroyl ethanolamide ester, disodium polyoxyethylene alkyl sulfosuccinate, carboxylated polyoxyethylene lauryl ether sodium salt, carboxylated polyoxyethylene lauryl ether sodium salt, carboxylated polyoxyethylene tridecyl ether sodium salt, polyoxyethylene lauryl ether sodium sulfate, polyoxymethylene lauryl ether triethanolamine sulfate, polyoxyethylene alkyl ether sodium sulfate, polyoxyethylene alkyl ether sodium sulfate, sodium alkyl sulfate, and triethanolamine alkyl sulfate. Examples are by not means limited to these. Such an anionic substance may preferably be used in an amount ranging from 0.05% by weight to 10% by weight, and more preferably from 0.05% by weight to 5% by weight, based on the total weight of the ink composition.

As the pigment usable in the anionic ink composition, a self-dispersion type pigment may also be used, which is capable of being dispersed in water or an aqueous medium without using any dispersant. The self-dispersion type pigment is a pigment to the particle surfaces of which at least one anionic hydrophilic group has been bonded directly or via a different atomic group. Such a pigment may include, e.g., one having at least one selected from hydrophilic groups shown below, and one in which a hydrophilic group is bonded via an atomic group such as an alkyl group having 1 to 12 carbon atoms, a substituted or unsubstituted phenyl group and a substituted or unsubstituted naphthyl group.

Examples of the hydrophilic group may include a carboxyl group and a sulfonic group.

The solvent contained in the ink composition of the present invention is meant to be, but is not particularly limited to, a medium capable of dissolving, suspending or dispersing ingredients contained in the ink composition. In the present invention, the solvent may include organic solvents such as various kinds of straight-chain, branched or cyclic aliphatic hydrocarbons, aromatic hydrocarbons and heterocyclic aromatic hydrocarbons; water-soluble solvents; and water.

In particular, water and a water-soluble solvent may preferably be used in the ink composition of the present invention.

Examples of the water-soluble solvent may include, e.g., polyhydric alcohols such as ethylene glycol, diethylene glycol, triethylene glycol, polyethylene glycol, propylene glycol, polypropylene glycol and glycerol; polyhydric alcohol ethers such as ethylene glycol monomethyl ether, ethylene glycol monoethyl ether, ethylene glycol monobutyl ether, diethylene glycol monoethyl ether and diethylene glycol monobutyl ether; and nitrogen-containing solvents such as N-methyl-2-pyrrolidone, substituted pyrrolidone, and triethanolamine. Also, as uses of inks, monohydric alcohols such as methanol, ethanol and isopropyl alcohol may be used for the purpose of accelerating the drying on paper.

The water or water-soluble solvent contained in the ink composition of the present invention may preferably be in a content ranging from 20% by weight to 95% by weight, and more preferably from 30% by weight to 90% by weight, based on the total weight of the aqueous dispersion (ink composition).

A preferred embodiment of the present invention is a composition in which the ink composition has a pH value of 5 or more, and more preferably a pH value of 7 or more.

To the ink composition of the present invention, various additives, auxiliaries or the like may be added as needed. A polymer may also be used which has both a hydrophilic moiety and a hydrophobic moiety. The polymer having both a hydrophilic moiety and a hydrophobic moiety may include, e.g., a copolymer of a hydrophilic monomer and a hydrophobic monomer. The hydrophilic monomer includes acrylic acid, methacrylic acid, maleic acid and fumaric acid, or monoesters of these carboxylic acids, and also vinylsulfonic acid, styrene sulfonic acid, vinyl alcohol, acrylamide, and methacryloxyethyl phosphate. The hydrophobic monomer includes styrene and styrene derivatives such as α-methylstyrene; as well as vinyl cyclohexane, vinylnaphthalene derivatives, acrylates and methacrylates. Of course, both hydrophilic and hydrophobic monomers are not limited to the foregoing.

Examples of the additives contained in the composition of the present invention may include a cross-linking agent, an acid generator, a polymerization initiator and so forth which are activated upon application of heat or electromagnetic waves.

Other additives that may be added to the composition of the present invention include a pH adjuster for stabilizing inks and achieving stability of inks with piping in a recording apparatus, a penetrant which allows inks to quickly penetrate the recording medium to accelerate apparent drying, a mildew proofing agent which prevents mildew from growing in inks, a chelating agent which blocks metallic ions in inks to prevent metals from depositing at nozzles or prevent insolubles from being deposited in inks, an anti-foaming agent which prevents foam from being produced when recording solutions are circulated or moved or recording solutions are prepared, an antioxidant, a viscosity modifier, a conducting agent, an ultraviolet absorber and so forth.

The preferred embodiment of the ink composition of the present invention is described below. Referring to a method for preparing the ink-jet recording ink composition of the present invention, the coloring material and the dispersant may be added to water and water-soluble solvent and dispersed therein using a dispersion machine, thereafter coarse particles are removed by means of centrifugation or the like, and then water or a solvent, additives, etc. are added, followed by stirring, mixing and filtration to prepare the ink composition.

As the dispersion machine, usable are, e.g., an, ultrasonic homogenizer, a laboratory homogenizer, a colloid mill, a jet mill, a ball mill and so forth. Any of these may be used alone or in combination.

The liquid-applying method of the present invention is described next.

(Liquid-Applying Method)

The ink composition of the present invention may be used in various image forming apparatus carried out by various kinds of printing, ink-jet recording, electrophotography and so forth, or pattern forming apparatus in semiconductor processing or the like, and images can be drawn by a liquid-applying method making use of such apparatus. In particular, the ink composition of the present invention may preferably be used in ink-jet recording. The ink-jet recording may be a known method such as a piezoelectric ink-jet recording system making use of piezoelectric elements, or a thermal ink-jet recording system which causes heat energy to act on inks to effect bubbling to perform recording. Also, either method of a continuous type and an on-demand type may be used. Still also, the ink composition of the present invention may be used in a recording system in which inks are applied on an intermediate transfer material and then transferred to a final recording medium such as paper.

In the recording medium/ink composition set in the present invention, where it is used for ink-jet recording, the following different stimuli (or exciting means) may be used in combination. Inks can be agglomerated by the following (a) to (c) stimuli.

(a) When used as ink which responds to temperature stimulus:

The ink composition of the present invention causes a phase change because of a temperature stimulus due to the difference between the temperature of ink in an ink tank and the temperature of ink on a recording medium to which the ink has adhered upon ejection, so that it thickens abruptly or insoluble components agglomerate.

(b) When used as ink which responds to electromagnetic-wave stimulus:

An electromagnetic-wave stimulus can be applied by a method in which the interior of an ink tank is set to be a darkroom and ink is exposed to visible light upon ejection, or a method in which ink is irradiated with electromagnetic waves from an electromagnetic-wave irradiation part provided in an ink-jet recording apparatus. Such an electromagnetic-wave stimulus causes polymerization functional groups contained in the ink-jet recording ink composition of the present invention to undergo polymerization, so that the ink thickens or insoluble components agglomerate.

(c) When ink-jet recording ink composition is used which responds to stimulus caused by change in concentration:

Because of a change in concentration of ink between the concentration of ink in an ink tank and the concentration of ink after the water and water-soluble solvent contained in the ejected ink evaporates from, or is absorbed in, the recording medium, the ink-jet recording ink composition of the present invention causes a phase change, so that the ink thicken or insoluble components agglomerate.

These changes in characteristics of ink enable color blur or feathering to be remedied, or enable superior fixing performance to be achieved. In addition, the changes of the ink characteristics are by no means limited to the above thickening or agglomeration of insoluble components.

The liquid-applying apparatus of the present invention is described next.

(Liquid-Applying Apparatus)

The ink-jet recording apparatus (liquid-applying apparatus) making use of the ink-jet recording ink composition of the present invention includes ink-jet recording apparatus of a piezoelectric ink-jet recording system making use of piezoelectric elements, or a thermal ink-jet recording system which causes heat energy to act on inks to effect bubbling to perform recording.

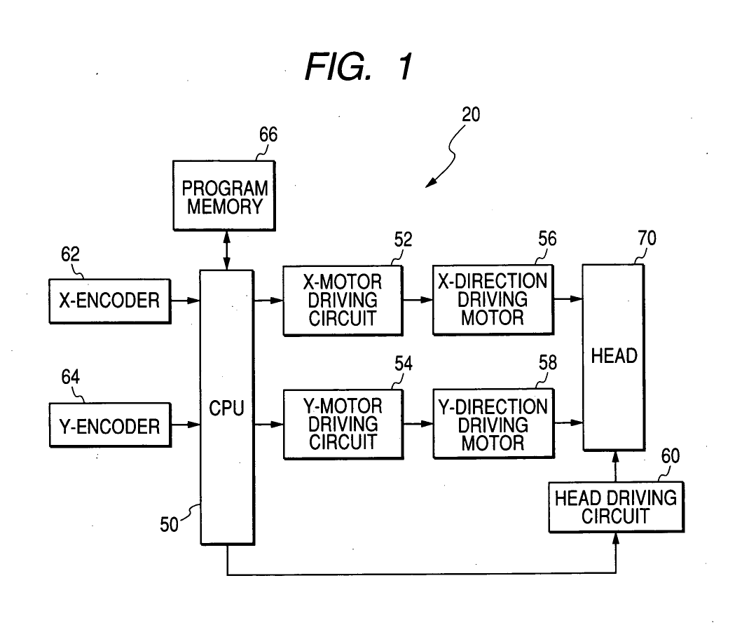

FIG. 1 schematically shows how the ink-jet recording apparatus functions. Reference numeral 50 denotes a central processing unit (CPU) of the ink-jet recording apparatus. A program for controlling the CPU 50 may be stored in a program memory 66, or in a memory means such as EPROM (not shown) as a firmware. In the ink-jet recording apparatus, recorded data are received in the program memory 66 from a recorded data preparation means (not shown; such as a computer). The recorded data may be information on images or characters to be recorded, or compressed information thereof, or encoded information. Where such compressed or encoded information is processed, the CPU 50 is allowed to perform elongation or expansion to obtain information on images or characters to be recorded. An X-encoder 62 (relating to, e.g., X-direction or primary scanning direction) and Y-encoder 64 (relating to, e.g., Y-direction or secondary scanning direction) may be provided to notify the CPU 50 of the relative position of a head with respect to a recording medium.

On the basis of the information of the program memory 66, X-encoder 62 and Y-encoder 64, the CPU 50 transmits signals which are to record images, to an X-motor driving circuit 52, a Y-motor driving circuit 54 and a head driving circuit 60. The X-motor driving circuit 52 and the Y-motor driving circuit 54 drive an X-motor driving motor and a Y-motor driving motor, respectively, to move a head 70 relatively with respect to the recording medium and bring it to a recording position. At a time point the head 70 is brought to the recording position, the head driving circuit 60 transmits to the head 70 signals which command it to eject every kind of ink composition (Y, M, C, K) or a stimulus-providing substance to effect recording. The head 70 may be one for ejecting a monochrome ink composition or one for ejecting a plurality of ink compositions, or may have the function of ejecting the stimulus-providing substance together.

The ink composition of the present invention may also be used in an apparatus making use of a direct recording system in which inks are allowed to directly adhere to the recording medium, or in an indirect recording apparatus making use of a recording system in which images are formed by inks on an intermediate transfer material on which latent images are formed, and transferred to a final recording medium such as paper. The ink composition of the present invention may still also be applied to an apparatus making use of an intermediate transfer material according to the direct recording system.

Where the direct recording system is used, the cationic-polymer-containing recording medium as described above is used as the final recording medium. On the other hand, where the indirect recording system is used, the cationic-polymer-containing recording medium as described above may be used as the intermediate transfer material, or as the final recording medium.

### EXAMPLES

The present invention is described below in detail by giving Examples. The present invention is by no means limited to these Examples.

### Example 1

### Synthesis of CH₂═CHOCH₂CH₂O-(4-Pyr)

1,078.7 g (11.34 mols) of 4-hydroxypyridine was dissolved in 11 L of dimethylformamide, and 3,521 g (25.52 mols) of calcium carbonate was added to the solution formed.

1,329 g (12.47 mols) of 2-chloroethyl vinyl ether was poured into the resultant mixture, which was thereafter heated, and then stirred at 100 to 110° C. for 8 hours. Thereafter, this was cooled to room temperature, and then poured into 33 L of ice water.

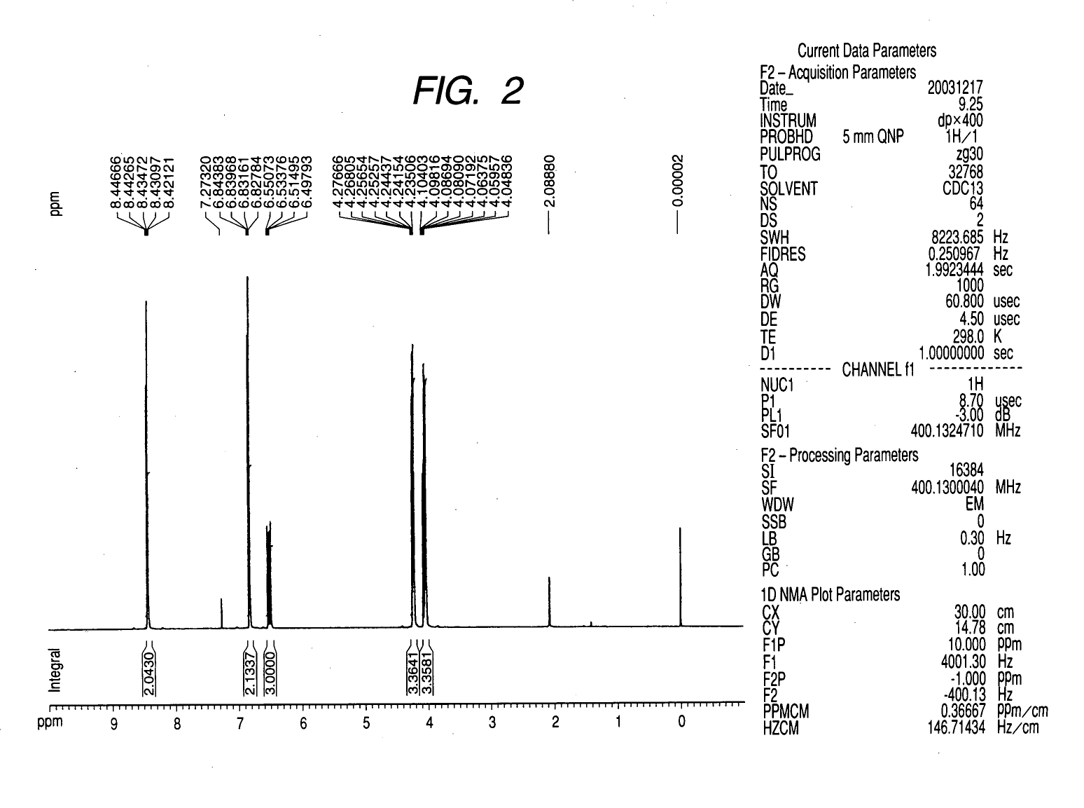

After extraction with toluene, the organic layer was washed with saturated brine, and dehydrated with magnesium sulfate, followed by concentration. This was purified by silica gel chromatography, and then decolored with activated carbon, followed by distillation under reduced pressure to obtain 341 g of CH₂═CHOCH₂CH₂O-(4-Pyr) (yield: 15.6%). An NMR chart of the polymerizable compound obtained is shown in FIG. 2.

### Example 2

### Synthesis of CH₂═CHOCH₂CH₂O-(4-(2,6-dimethyl)pyridine)

CH₂═CHOCH₂CH₂O-(4-(2,6-dimethyl)pyridine) (PyOVE) was obtained from 2,6-dimethyl-4-hydroxypyridine and 2-choroethyl vinyl ether in the same manner as in Example 1.

### Example 3

### Synthesis of High-Molecular Compound

### Polymerization of poly{2-vinyloxyethoxy-4-(2,6-dimethyl)pyridine} (Poly-PyOVE)

The inside atmosphere of a glass container fitted with a three-way cock was displaced with nitrogen, and then heated to 250° C. in the atmosphere of nitrogen gas to remove adsorbed water. After the system was returned to room temperature, 16 mmols (millimoles) of the PyOVE obtained in Example 2, 0.2 mmol of 1-isobutoxyethyl acetate and 35 ml of toluene were added, and the reaction system was cooled. At the time the temperature in the system reached 0° C., 1 mmol of ethylaluminum sesquichloride (an equimolar mixture of diethylaluminum chloride and ethylaluminum dichloride) was added to initiate polymerization. Molecular weight was monitored in a time-sharing way using molecular sieve column chromatography (GPC), and the polymerization reaction was stopped at the time a 30-mer was formed by polymerization. To stop the polymerization reaction, a 0.3% by weight ammonia/methanol aqueous solution was added to the system. The reaction mixture solution obtained was diluted with dichloromethane, followed by washing with 0.6 M hydrochloric acid three times and subsequently with distilled water three times. The organic layer obtained was concentrated and evaporated to dryness by means of an evaporator, and this was vacuum-dried. The vacuum-dried product was repeatedly dialyzed in a methanol solvent by the use of a cellulose semipermeable membrane to remove a monomeric compound, thus the desired product, a homopolymer, was obtained as the high-molecular compound. The compound was identified by NMR and GPC: Mn=3,000; Mw/Mn=1.24.

### Example 4

### Synthesis of CH₂═CHO(CH₂CH₂O)2-(4-Pyr)

Synthesis was carried out by means of reaction called the Mitsunobu reaction shown in the following reaction scheme (4) to yield the desired compound. 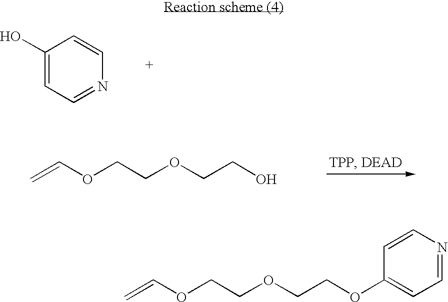
In the scheme, TPP represents triphenylphosphine; and DEAD, diethyl azodicarobxylate.

### Example 5

Polymerization was carried out in the same manner as in Example 3 using the polymerizable compound obtained in Example 4 to yield a high-molecular compound having a number-average molecular weight of 1,900 as measured by excluded-volume chromatography.

### Example 6

### Synthesis of Hydrochloride

The high-molecular compound obtained in Example 3 was suspended in methylene chloride, followed by addition of a 0.6N hydrochloric acid aqueous solution, and these were mixed by shaking in a separable funnel. The organic layer obtained was washed with water several times, and then concentrated and evaporated to dryness to produce a hydrochloride. Its structure was confirmed by ¹H NMR.

### Example 7

### Synthesis of Block Polymer

### Synthesis of Di-Block Polymer Composed of CH₂═CHOCH₂CH₂PhCH₃ (TolOVE: A-block) and 2-vinyloxyethoxy-4-(2,6-dimethyl)pyridine (PyOVE: B-block)

The inside atmosphere of a glass container fitted with a three-way cock was displaced with nitrogen, and then heated to 250° C. in the atmosphere of nitrogen gas to remove adsorbed water. After the system was returned to room temperature, 20 mmols (millimoles) of TolOVE, 52 mmols of ethyl acetate, 0.2 mmol of 1-isobutoxyethyl acetate and 35 ml of toluene were added, and the reaction system was cooled. At the time the temperature in the system reached 0° C., 1 mmol of ethylaluminum sesquichloride (an equimolar mixture of diethylaluminum chloride and ethylaluminum dichloride) was added to initiate polymerization. Molecular weight was monitored in a time-sharing way using molecular sieve column chromatography (GPC), where the polymerization for the A-block was confirmed to have been completed.

Next, a toluene solution of 4.6 mmols of PyOVE was added to continue polymerization. The polymerization reaction was stopped at the time the B-block came to be a pentamer or so. To stop the polymerization reaction, a 0.3% by weight ammonia/methanol aqueous solution was added to the system. The reaction mixture solution obtained was diluted with dichloromethane, followed by washing with 0.6 M hydrochloric acid three times and subsequently with distilled water three times. The organic layer obtained was concentrated to dryness by means of an evaporator, and was vacuum-dried. The vacuum-dried product was repeatedly dialyzed in a methanol solvent by the use of a cellulose semipermeable membrane to remove a monomeric compound, thus the desired product, a block polymer, was obtained as the high-molecular compound. The compound was identified by NMR and GPC: Mn=15,000; Mw/Mn=1.26. Its polymerization ratio was A:B=90:5.

### Example 8

### Synthesis of Hydrochloride

26 parts by weight of the polymer obtained by polymerization in Example 7 was stirred at 0° C. for 3 days together with 200 parts by weight of a pH 2 hydrochloric acid aqueous solution to form a hydrochloride polymer solution. Dialysis was carried out to remove excess hydrochloric acid, followed by drying to remove the solvent to isolate a hydrochloride type polymer.

### Example 9

2 parts by weight of a pigment (MOGUL-L, available from Cabot Corp.), 1 part by weight of the high-molecular compound of Example 7 and 15 parts by weight of diethylene glycol were added to 99 parts by weight of ion-exchange water, followed by dispersion using an ultrasonic homogenizer. The dispersion obtained was subjected to pressure filtration through a filter of 1 μm in pore size to prepare an ink composition. The pigment stood sufficiently dispersed.

### Example 10

Using the ink composition prepared in Example 9, ink-jet recording was performed. An ink tank of BUBBLE JET (registered trademark) Printer (trade name: BJF800), manufactured by CANON INC., was filled with the ink composition of Example 9, and recording was performed on plain paper by the use of the ink-jet printer, where black-characters were able to be neatly printed.

### Example 11

The polymer obtained in Example 3 was used to prepare a toner composition in the following way.

100 parts by weight of polyester resin (synthesized using bisphenol A, terephthalic acid, n-dodecenylsuccinic acid, trimellitic acid and diethylene glycol in a molar ratio of 20:38:10:5:27), 70 parts by weight of magnetite (Fe₃O₄), 2 parts by weight of the polymer obtained in Example 3, 2 parts by weight of triphenylmethane dye and 3 parts by weight of low-molecular weight polypropylene were preliminarily mixed, followed by melt-kneading by means of a melt-kneading machine. The resulting product was cooled, then crushed by means of a speed mill, thereafter finely pulverized by means of a jet mill, and further classified using a zigzag classifier to produce a toner with a volume-average particle diameter of 11 μm.

To 100 parts by weight of this toner, 0.4 part by weight of positively chargeable hydrophobic dry-process silica treated with amino-modified silicone oil (viscosity at 25° C.: 100 cp; amine equivalent weight: 800) and 0.2 part by weight of spherical PVDF (polyvinylidene fluoride) particles with an average particle diameter of 0.2 μm were added, and these were mixed by means of a Henschel mixer to prepare a positively chargeable toner composition. Using this toner composition, copying was performed using a copying machine NP-3525, manufactured by CANON INC., where neat copying was performable.

### Example 12

### Preparation of Cationic-Polymer-Containing Recording Medium

5 parts by weight of an aqueous solution of 50% by weight of the polymer hydrochloride obtained in Example 6 was mixed with 95 parts by weight of water with stirring and dissolved to prepare a coating solution. This coating solution was applied on woodfree paper (GINKAN, available from Sanyo-Kokusaku Pulp Co., Ltd.) by means of a wire bar to form a coating layer of 4 microns in thickness after dried, followed by drying at 70° C. for 10 minutes, and subjected to super calendering to produce a cationic-polymer-containing recording medium.

### Preparation of Anionic Ink Composition

4 parts by weight of a water-soluble dye (C.I. Direct Blue 199) and 17 parts by weight of diethylene glycol were stirred in 79 parts by weight of distilled water to prepare a water-soluble ink composition which was very transparent and took on blue color.

The ink composition thus obtained was filled in a printing head of an ink-jet printer (BJF800, manufactured by CANON INC.), and was ejected onto a recording medium to form images. As the recording medium, the cationic-polymer-containing recording medium obtained as described above was used. Evaluation was made on the recording medium and ink composition by the methods (1) and (2) shown below.

Method (1):

Using the above printer, a square solid image of 50 mm×50 mm was printed, and 30 seconds after the printing, the printed area was strongly pressed with a finger. The finger was observed, and according to the following criteria, the fixing performance of the ink on the recording medium was evaluated.
A: No ink adhered to the finger at all.
B: Ink adhered to part of the finger.
C: Ink adhered all over the finger.

Method (2):

Using the above printer, a square solid image of 50 mm×50 mm was printed, and 30 seconds after the printing, the image was strongly rubbed stated times with a line marker, and bleeding from the trailing edge was observed, and according to the following criteria, the fixing performance of ink on the recording medium was evaluated.
AA: No bleeding of blue color was seen even when the image was strongly rubbed five times with the line marker.
A: No bleeding of blue color was seen even when the image was strongly rubbed four times with the line marker.
B: No bleeding of blue color was seen even when the image was strongly rubbed twice with the line marker.
C: Bleeding of blue color was seen when the image was strongly rubbed once with the line marker.

Evaluation was made on the cationic-polymer-containing recording medium obtained as described above, to find that all evaluation results were “A”.

### Comparative Example 1

The ink composition obtained in Example 12 was filled in a printing head of an ink-jet printer (BJF800, manufactured by CANON INC.), and was ejected onto each recording medium to form images. As the recording medium, woodfree paper (GINKAN, available from Sanyo-Kokusaku Pulp Co., Ltd.) not coated with the coating solution of Example 12 was used. Evaluation was made in the same manner as in Example 12. The results of evaluation were “C” in both of Methods (1) and (2).

### Comparative Example 2

A cationic-polymer-containing recording medium was prepared in the same manner as in Example 12 except that polyarylamine hydrochloride (number-average molecular weight Mn: 3,200) was used in place of the cationic polymer obtained in Example 6. Evaluation was also made in the same manner as in Example 12. The evaluation results were “B” in both Methods (1) and (2).

### Example 13

### Synthesis of Tri-Block Polymer Composed of isobutyl vinyl ether and biphenyloxyethyl vinyl ether (IBVE-r-VEETPhPh: A-block), diethylene glycol methyl vinyl ether (MOEOVE: B-block) and ethyl 4-(2-vinyloxy)ethoxybenzoate (VEEtPhCOOEt: C-block), Having Anionic Block Segments, i.e., poly[(IBVE-r-VEETPhPh)-b-MOEOVE-b-VEEtPhCOOH] (Wherein b and t are Letter Symbols Standing for a Block Polymer and a Random Polymer, Respectively)

The inside atmosphere of a glass container fitted with a three-way cock was displaced with nitrogen, and then heated to 250° C. in the atmosphere of nitrogen gas to remove adsorbed water. After the system was returned to room temperature, 2.5 mmols (millimoles) of IBVE, 2.5 mmols of VEETPhPh, 16 mmols of ethyl acetate, 0.05 mmol of 1-isobutoxyethyl acetate and 11 ml of toluene were added, and the reaction system was cooled. At the time the temperature in the system reached 0° C., 0.2 mmol of ethylaluminum sesquichloride (an equimolar mixture of diethylaluminum chloride and ethylaluminum dichloride) was added to, initiate polymerization. Molecular weight was monitored in a time-sharing way using molecular sieve column chromatography (GPC), where the polymerization for the A-block was confirmed to have been completed.

Next, 4.4 mmols (millimoles) of MOEOVE was added as a B-block component to continue polymerization. By monitoring making use of GPC, the polymerization for the B-block was confirmed to have been completed. Thereafter, 5.0 mmols of ethyl 4-(2-vinyloxy)ethoxybenzoate was added as a C-block component to continue polymerization. After 3 hours, the polymerization reaction was stopped. To stop the polymerization reaction, an 0.3% by weight ammonia/methanol aqueous solution was added to the system. The reaction mixture solution obtained was diluted with dichloromethane, followed by washing with 0.6 mol/L hydrochloric acid three times and subsequently with distilled water three times. The organic layer obtained was concentrated to dryness by means of an evaporator, and vacuum-dried. The vacuum-dried product was repeatedly dialyzed in a methanol solvent by the use of a cellulose semipermeable membrane to remove a monomeric compound, thus the desired product, a tri-block polymer, was obtained as the high-molecular compound. The compound was identified by NMR and GPC: Mn=26,500; Mw/Mn=1.34. Its polymerization ratio was A:B:C=10:90:10. The two kinds of monomers in the A-block were in a weight ratio of 1:1.

The tri-block polymer obtained here was hydrolyzed in a mixture solution of dimethylformamide, sodium hydroxide and water, thereby hydrolyzing the ethyl 4-(2-vinyloxy)ethoxybenzoate in the C-block component to produce a tri-block polymer made into a sodium salt. The compound was identified by NMR and GPC.

This polymer was neutralized with 0.1N hydrochloric acid in a water dispersion to produce a tri-block polymer in which the ethyl 4-(2-vinyloxy)ethoxybenzoate in the C-block component was converted into a free carboxylic acid, i.e., poly[(IBVE-r-VEETPhPh)-b-MOEOVE-b-VEEtPhCOOH]. The compound was identified by NMR and GPC.

### Preparation of Anionic Ink Composition

26 parts by weight of the block polymer obtained as described above, having anionic block segments, and 10 parts by weight a fat-soluble dye OIL BLUE N (same as trade name; available from Aldrich Chemical Co., Inc.) were co-dissolved in dimethylformamide, and the solution obtained was converted into an aqueous phase by using 400 parts by weight of distilled water to prepare an ink composition. To this ink composition, 0.1 ml of an 0.1 N sodium hydroxide aqueous solution was added. The mixture obtained was subjected to homogenization using an ultrasonic homogenizer for 10 minutes, and left standing for 1 hour. On a pH test paper, the pH was 12. This dispersion was very transparent and took on blue color. This was left for 10 days, but no fat-soluble dye was separated and precipitated.

The ink composition thus obtained was filled in a printing head of an ink-jet printer (BJF800, manufactured by CANON INC.), and was ejected onto a recording medium to form images. As the recording medium, the cationic-polymer-containing recording medium obtained in Example 12 was used. Evaluation was made on the recording medium and ink composition by Methods (1) and (2) shown in Example 12.

Evaluation was made on the cationic-polymer-containing recording medium obtained in Example 12, to find that the results in Methods (1) and (2) were “A” and “AA”, respectively.

This application claims priority from Japanese Patent Application Nos. 2004-062473 filed on Mar. 5, 2004 and 2004-139192 filed on May 7, 2004, which are hereby incorporated by reference herein.

1. A polymerizable compound represented by the following general formula (1):
XO(AO)mBD (1)
wherein X represents an alkenyl group; A represents a substituted or unsubstituted, straight-chain or branched alkylene group having 1 to 15 carbon atoms; m represents an integer of 0 to 30, and, when m is plural, A's may be different; B represents a single bond or a substituted or unsubstituted alkylene group; and D represents an aromatic amine or amino group, or an acid salt thereof.

2. A high-molecular compound having a repeating structural unit represented by the following general formula (2): 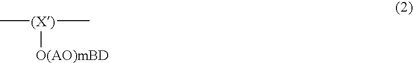
wherein X′ represents an alkenyl group; A represents a substituted or unsubstituted, straight-chain or branched alkylene group having 1 to 15 carbon atoms; m represents an integer of 0 to 30, and when m is plural, A's may be different; B represents a single bond or a substituted or unsubstituted alkylene group; and D represents an aromatic amine or amino group, or an acid salt thereof.

3. The high-molecular compound according to claim 2, which is a block copolymer.

4. A composition comprising the high-molecular compound according to claim 2, a solvent or a dispersant, and a functional substance.

5. The composition according to claim 4, wherein said functional substance is enclosed by said high-molecular compound.

6. The composition according to claim 4 or 5, which is a recording material in which said functional substance is a coloring material.

7. An image recording method comprising:
the step of preparing the recording material according to claim 6; and
the step of recording an image on a medium by using the recording material.

8. An image recording apparatus comprising a means for recording an image on a medium by using the recording material according to claim 6.

9. A recording medium comprising a polymer having as a repeating structural unit an alkenyl ether structure exhibiting cationic properties.

10. The recording medium according to claim 9, wherein said polymer has a repeating structural unit represented by the following general formula (2): 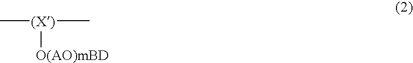
wherein X′ represents an alkenyl group; A represents a substituted or unsubstituted, straight-chain or branched alkylene group having 1 to 15 carbon atoms; m represents an integer of 0 to 30, and when m is plural, A's may be different; B represents a single bond or a substituted or unsubstituted alkylene group; and D represents an aromatic amine or amino group, or an acid salt thereof.

11. The recording medium according to claim 9, wherein said alkenyl ether structure is a vinyl ether structure.

12. The recording medium according to claim 9, which is a sheet comprising paper.

13. A recording medium/functional-substance dispersed composition set comprising a combination of the recording medium according to claim 9 and a functional-substance dispersed composition which exhibits anionic properties and contains an aqueous medium and a functional substance.

14. The recording medium/functional-substance dispersed composition set according to claim 13, wherein said functional-substance dispersed composition is an ink composition prepared by dispersing a water-soluble anionic dye or a fat-soluble dye or pigment in an aqueous medium by using an anionic dispersant.

15. The recording medium/functional-substance dispersed composition set according to claim 13, wherein said functional-substance dispersed composition is an ink composition prepared by dispersing a fat-soluble dye or pigment in an aqueous medium by using a polymer having as a repeating structural unit a vinyl ether structure exhibiting anionic properties.

16. The recording medium/functional-substance dispersed composition set according to claim 13, wherein said ink composition is an ink for ink-jet recording.

17. A liquid-applying method which comprises using the recording medium/ink composition set according to claim 16.

18. A liquid-applying apparatus used in the liquid-applying method according to claim 17.
